(19) United States
(12) Patent Application Publication
(10) Pub. No.: US 2008/0151690 A1
(43) Pub. Date: Jun. 26, 2008

(54) Imaging Near-Borehole Reflectors Using Shear Wave Reflections From a Multi-Component Acoustic Tool

(75) Inventors: Xiao Ming Tang, Sugar Land, TX (US); Douglas J. Patterson, Spring, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/961,349

(22) Filed: Dec. 20, 2007

Related U.S. Application Data
(60) Provisional application No. 60/871,895, filed on Dec. 26, 2006.

(51) Int. Cl. G01V 1/40

(52) U.S. Cl. 367/35; 702/11

(57) ABSTRACT

Shear wave reflection data obtained by a cross dipole tool are rotated to a fixed coordinate system and migrated to produce an image of an earth formation.

### CROSS-REFERENCES TO RELATED APPLICATIONS

This application claims priority from U.S. Provisional Patent Application Ser. No. 60/871,895 filed on Dec. 26, 2006.

### BACKGROUND OF THE DISCLOSURE

1. Field of the Disclosure

The disclosure relates to the field of acoustic logging of formations in a borehole. In particular, the disclosure discusses a method for imaging a downhole formation using shear waves from a dipole acoustic logging tool.

2. Description of the Related Art

In order to obtain hydrocarbons such as oil and gas, boreholes or wellbores are drilled through hydrocarbon-bearing subsurface formations. Logging tests are subsequently made to determine the properties of formations surrounding the borehole. In wireline logging, a drilling apparatus that forms the borehole is removed so that testing equipment can be lowered into the borehole for testing. In measurement-while-drilling techniques, the testing equipment is conveyed down the borehole along with the drilling equipment. These tests may include resistivity testing equipment, gamma radiation testing equipment, seismic imaging equipment, etc.

Seismic imaging using borehole acoustic measurements can obtain an image of the formation structural changes away from the borehole (Hornby, B. E., 1989, Imaging near-borehole of formation structure using full-waveform sonic data, Geophysics, 54, 747-757; Li et al., 2002, Single-well imaging with acoustic reflection survey at Mounds, Oklahoma, USA, 64th EAGE Conference & Exhibition. Paper P 141; and Zheng and Tang, 2005, Imaging near-borehole structure using acoustic logging data with pre-stack F-K migration: 75th Ann. Internat. Mtg.: Soc. of Expl. Geophys. In the past, near-borehole acoustic imaging was exclusively performed using compressional-wave measurements made by monopole acoustic tools. Typically, monopole compressional waves with a center frequency around 10 kHz are commonly used for the imaging. The acoustic source of a monopole tool has a uniform azimuthal radiation and the receivers of the tool record wave energy from all azimuthal directions. Consequently, acoustic imaging using monopole tools is unable to determine the strike azimuth of the near-borehole structure.

A very useful property of a dipole source or dipole receiver system is its directionality. That is, the generated or the received wave amplitude depends on the angle φ between the wave's associated particle motion direction (polarization) and the source or receiver orientation. Dipole acoustic logging has commonly been used to measure formation shear wave velocity and determine formation azimuthal shear-wave anisotropy (e.g., Tang and Chunduru, 1999, Simultaneous inversion of formation shear-wave anisotropy parameters from cross-dipole acoustic-array waveform data, Geophysics, Soc. of Expl. Geophys., 64, 1502-1511).

Directional acoustic measurement using dipole tools have the potential to measure an azimuth of reflector plane. Application of the technique to dipole shear-wave logging data allows for extracting low-frequency shear-wave reflections from the data. One issue in determining azimuth is an ambiguity in selecting from possible azimuthal candidates that is not addressed by monopole tools. The directional aspects of shear waves can be explored for imaging applications. Thus, there is a need to use shear waves from a dipole acoustic source to resolve the azimuth ambiguity and to image near-borehole reflector geometry.

### SUMMARY OF THE DISCLOSURE

One embodiment of the disclosure is a method of imaging an earth formation. Acoustic waves are generated in the earth formation using a plurality of transmitters on a multicomponent logging tool in a borehole in the earth formation. A plurality of multicomponent measurements are made of shear waves reflected from bed boundaries for each of the plurality of transmitters. A measurement is made of the orientation of the logging tool. The plurality of multicomponent measurements are rotated to a fixed coordinate system using the measured orientation. The rotated measurements are processed to obtain an image of the earth formation. The method may further include determining an azimuth of a bed boundary in the earth formation and/or a depth of a bed boundary in the earth formation. The measurements may include those made by a cross-dipole tool. The orientation measurements may be made with a magnetometer. The measurements may be made at the plurality of depths in the borehole. The processing may include applying a high-pass filtering, determining a first break, using survey information indicative of the position of a source and a receiver on a logging tool, applying an f-k filtering operation, and/or applying a dip median filter. The processing may further include performing a migration.

Another embodiment of the disclosure is an apparatus for imaging an earth formation. The apparatus includes a logging tool conveyed in a borehole in the earth formation. The logging tool includes a multicomponent transmitter configured to generate a shear wave in the formation and a receiver which obtains multicomponent measurements of shear waves reflected from at least one bed boundary in the earth formation. The apparatus includes an orientation sensor configured to provide an orientation measurement of the logging tool. The apparatus further includes a processor configured to rotate the plurality of multicomponent measurements to a fixed coordinate system using the orientation measurement, and process the rotated multicomponent measurements to provide an image of the earth formation. The processor may further be configured to estimate an azimuth of the bed boundary and/or a dip of the bed boundary in the formation. The orientation sensor may include a magnetometer. The processor may further be configured to apply a high-pass filtering, detecting a first break, use survey information indicative of a position of the source and a receiver on the logging tool, applying an f-k filtering operation, apply a dip median filter, and/or select a time window. The processor may further be configured to perform a migration operation.

Another embodiment of the disclosure is a computer-readable medium for use with an apparatus for imaging an earth formation. The apparatus includes a logging tool conveyed in a borehole in the earth formation. The logging tool includes a multicomponent transmitter configured to generate a shear wave in the formation and a receiver which obtains multicomponent measurements of shear waves reflected from at least one bed boundary in the earth formation. The apparatus includes an orientation sensor configured to provide an orientation measurement of the logging tool. The medium includes instructions which enable a processor to rotate the plurality of multicomponent measurements to a fixed coordinate system using the orientation measurement, and process the rotated multicomponent measurements to provide an image of the earth formation. The machine readable medium may include a ROM, an EPROM, an EEPROM, a flash memory and/or an optical disk.

### BRIEF DESCRIPTION OF THE DRAWINGS

For detailed understanding of the present disclosure, references should be made to the following detailed description of the preferred embodiment, taken in conjunction with the accompanying drawings, in which like elements have been given like numerals and wherein:

FIG. 1 shows a schematic diagram of a drilling system that employs the apparatus of the current disclosure in a logging-while-drilling (LWD) embodiment;

FIG. 2 depicts a three-dimensional view of a shear-wave radiation pattern for a dipole source directed along the x-direction of a rectilinear coordinate system;

FIG. 3 illustrates a shear wave reflection plane crossing a borehole having a dipole tool conveyed within;

FIG. 4 shows a graph of angular dependence of reflection coefficients between two media for shear vertical and shear horizontal waves;

FIG. 5A shows a flowchart for determining a bedding plane orientation using directional acoustic logging data obtained from a four-component cross-dipole acoustic logging tool in a borehole;

FIG. 5B shows a flowchart for determining a bedding plane orientation using directional acoustic logging data from an in-line dipole tool in a borehole;

FIG. 6 shows four-component cross-dipole data acquired in a vertical well surrounded by a sand/shale formation;

FIG. 7 shows four-component data of FIG. 6 after reflection processing;

FIG. 8 shows four-component data after reflection processing, a cross-energy difference, and a ratio of SH to SV for a recording time period;

FIG. 9 shows an exemplary obtained image of bed-boundary reflectors across an exemplary borehole; and

FIG. 10 illustrates the geometry of a testing tool conveyed in a borehole intersecting a reflector plane.

### DETAILED DESCRIPTION OF THE DISCLOSURE

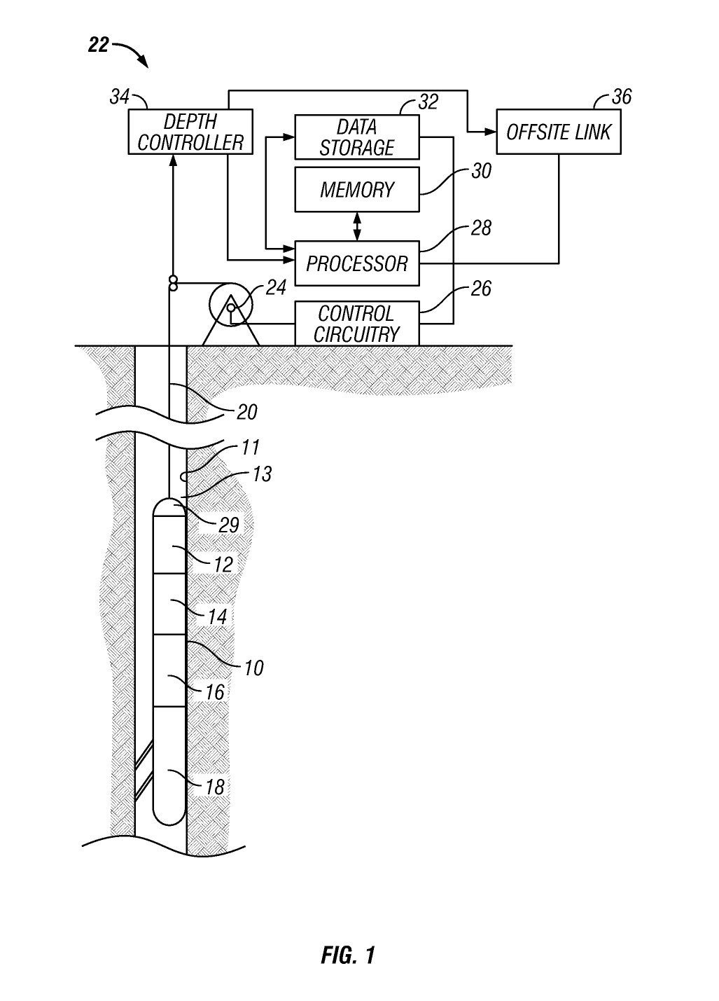

A typical configuration of the logging system is shown in FIG. 1. This is a modification of an arrangement from U.S. Pat. No. 4,953,399 to Fertl et al., having the same assignee as the present disclosure, the contents of which are incorporated herein by reference. Shown in FIG. 1 is a suite of logging instruments 10, disposed within a borehole 11 penetrating an earth formation 13, illustrated in vertical section, and coupled to equipment at the earth's surface, in accordance with various illustrative embodiments of the method and apparatus of the present disclosure. Logging instrument suite 10 may include a resistivity device 12, a natural gamma ray device 14, and/or two porosity-determining devices, such as a neutron device 16 and/or a density device 18. Collectively, these devices and others used in the borehole for logging operations are referred to as formation evaluation sensors. The resistivity device 12 may be one of a number of different types of instruments known to the art for measuring the electrical resistivity of formations surrounding a borehole so long as such device has a relatively deep depth of investigation. For example, a HDIL (High Definition Induction Logging) device such as that described in U.S. Pat. No. 5,452,761 to Beard et al., having the same assignee as the present disclosure, the contents of which are fully incorporated herein by reference, may be used. The natural gamma ray device 14 may be of a type including a scintillation detector including a scintillation crystal cooperatively coupled to a photomultiplier tube such that when the crystal is impinged by gamma rays a succession of electrical pulses is generated, such pulses having a magnitude proportional to the energy of the impinging gamma rays. The neutron device 16 may be one of several types known to the art for using the response characteristics of the formation to neutron radiation to determine formation porosity. Such a device is essentially responsive to the neutron-moderating properties of the formation. The density device 18 may be a conventional gamma-gamma density instrument such as that described in U.S. Pat. No. 3,321,625 to Wahl, used to determine the bulk density of the formation. A downhole processor 29 may be provided at a suitable location as part of the instrument suite.

The logging instrument suite 10 is conveyed within borehole 11 by a cable 20 containing electrical conductors (not illustrated) for communicating electrical signals between the logging instrument suite 10 and the surface electronics, indicated generally at 22, located at the earth's surface. The logging devices 12, 14, 16, and/or 18 within the logging instrument suite 10 are cooperatively coupled such that electrical signals may be communicated between each of the logging devices 12, 14, 16, and/or 18 and the surface electronics 22. The cable 20 is attached to a drum 24 at the earth's surface in a manner familiar to the art. The logging instrument suite 10 is caused to traverse the borehole 11 by spooling the cable 20 on to or off of the drum 24, also in a manner familiar to the art.

The surface electronics 22 may include such electronic circuitry as is necessary to operate the logging devices 12, 14, 16, and/or 18 within the logging instrument suite 10 and to process the data therefrom. Some of the processing may be done downhole. In particular, the processing needed for making decisions on speeding up (discussed below) or slowing down the logging speed is preferably done downhole. If such processing is done downhole, then telemetry of instructions to speed up or slow down the logging could be carried out substantially in real time. This avoids potential delays that could occur if large quantities of data were to be telemetered uphole for the processing needed to make the decisions to alter the logging speed. It should be noted that with sufficiently fast communication rates, it makes no difference where the decision-making is carried out. However, with present data rates available on wirelines, the decision-making is preferably done downhole.

Control circuitry 26 contains such power supplies as are required for operation of the chosen embodiments of logging devices 12, 14, 16, and/or 18 within the logging instrument suite 10 and further contains such electronic circuitry as is necessary to process and normalize the signals from such logging devices 12, 14, 16, and/or 18 in a conventional manner to yield generally continuous records, or logs, of data pertaining to the formations surrounding the borehole 11. These logs may then be electronically stored in a data storage 32 prior to further processing. A surface processor 28 may process the measurements made by the formation evaluation sensor(s) 12, 14, 16, and/or 18. This processing could also be done by the downhole processor 29.

The surface electronics 22 may also include such equipment as will facilitate machine implementation of various illustrative embodiments of the method of the present disclosure. The surface processor 28 may be of various forms, but preferably is an appropriate digital computer programmed to process data from the logging devices 12, 14, 16, and/or 18. A memory unit 30 and the data storage unit 32 are each of a type to interface cooperatively with the surface processor 28 and/or the control circuitry 26. A depth controller 34 determines the longitudinal movement of the logging instrument suite 10 within the borehole 11 and communicates a signal representative of such movement to the surface processor 28. The logging speed is altered in accordance with speedup or slowdown signals that may be communicated from the downhole processor 29, and/or provided by the surface processor 28, as discussed below. This is done by altering the rotation speed of the drum 24. Offsite communication may be provided, for example, by a satellite link, by a telemetry unit 36.

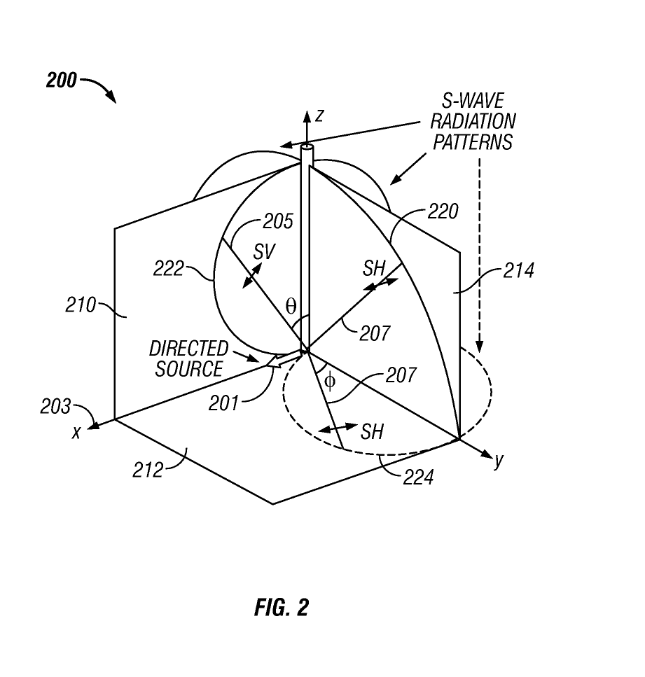

The present disclosure includes an acoustic logging source. FIG. 2 depicts a three-dimensional view of a shear-wave radiation pattern for a dipole source directed along the x-direction of a rectilinear coordinate system. The dipole source may be used, for example, in an acoustic logging tool conveyed downhole on the LWD device of FIG. 1. In general, the z-axis is oriented along the tool axis. Dipole radiation source 201 is oriented along the x-axis 203 of a related coordinate system. The dipole source gives rise to a shear vertical (SV) wave polarized in a vertical plane of the coordinate system and a shear horizontal (SH) wave polarized in a horizontal plane of the coordinate system. The azimuthal dependences of the SV 205 and SH 207 waves generated by the borehole dipole source are respectively shown in Eq. (1):

u_{θ}∝ sin φ (SV wave)

u_{φ}∝ cos φ (SH wave) (1)

where φ is azimuthal angle and θ is an angle measured from vertical (z-direction); u_{φ} and u_{θ} are respectively the SH-wave and SV-wave displacement.

As viewed in the vertical y-z plane 214 with φ=0°, the radiated shear wave is a pure SH wave with an invariant radiation pattern that displays a circular pattern 220. When the dipole source is conveyed in a borehole, the circular pattern enables the SH wave to illuminate a reflector that may cross the borehole at various dip angles. In the vertical x-z plane 210 with φ=90°, the radiated shear wave is a pure SV wave with a cos θ functional dependence 222. In the horizontal x-y plane 212, in the far-field or long wavelength region, the radiated shear wave u_{φ} is a pure SH wave that is a function of cos θ 224.

The dipole radiation typically has a wider coverage in the vertical plane compared to radiation for a monopole source. The SV and SH waves respectively possess a cos θ and sin θ azimuthal sensitivity, which may form a basis for determining reflector azimuth from data obtained using the dipole shear-wave.

As used in a borehole, the far-field radiation of an acoustic dipole source is equivalent to that of a single force or a suitable equivalent for a system in an elastic solid, whereas the radiation pattern (Ben-Menahem and Kostek, 1991) is given by

u_{θ}∝ cos θ sin φ

u_{φ}∝ cos φ (2)

By comparison, the azimuthal dependence of the borehole dipole source (Eq. (1)) is the same as that of a single force (Eq. (2)). Also, in the far-field or long wavelength scenario, the function dependence (cos θ) of the associated u_{φ}-pattern in the horizontal plane 212 is the same as that of u_{θ} in the vertical plane (cos θ) shown in FIG. 2.

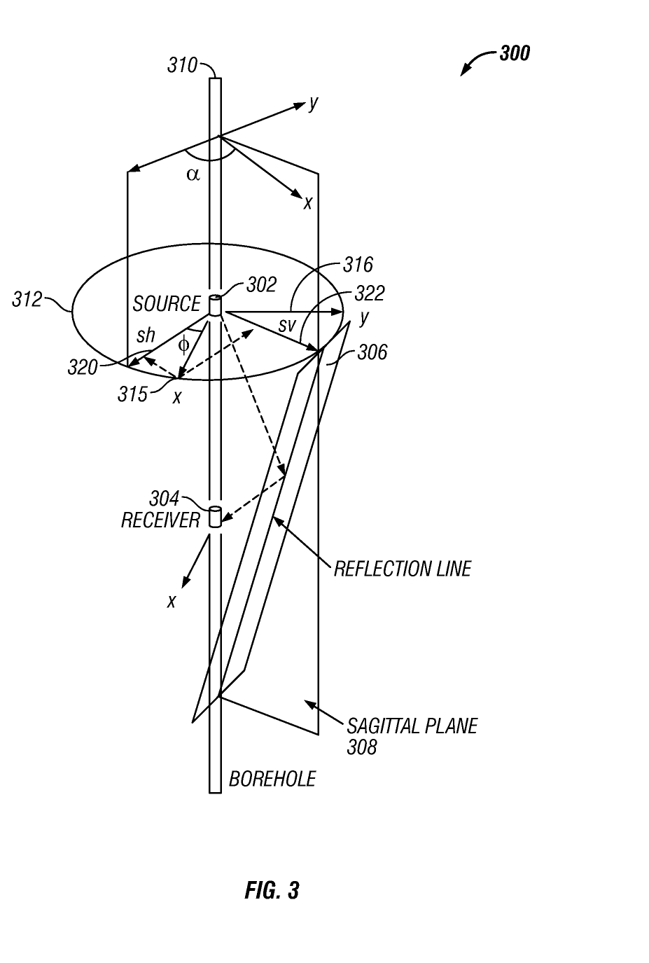

FIG. 3 illustrates a shear wave reflection plane crossing a borehole having a four-component cross-dipole tool conveyed within. The tool comprises a dipole source 302 and a receiver 304 axially separated from the source along the tool conveyed in borehole 310. The borehole is incident to reflector plane 306, which may be, for example, a geologic formation boundary. Source 302 has associated with it a tool coordinate system defined by a z-axis substantially parallel to the borehole axis and tool axes x (315) and y (316) which define a plane 312 transverse to the borehole axis. An incident plane, or sagittal plane 308, contains the borehole and the dip direction of the reflector plane. For the entire reflector plane 306, recorded reflection is that which occurs only in the wave incident plane. The x-dipole source 302 is oriented along the tool x-axis 315 which makes an angle of φ with the normal of the incident plane 308.

Because the radiation of a dipole source is equivalent to that of a single force in the far-field, the force vector represents the source and can be decomposed into orthogonal components using projection. For the transverse plane 312 containing the x- and y-axes at the source, the respective projections of the x-dipole to the normal of the sagittal plane (i.e., strike of the reflector plane) and to the plane itself are labeled as sh 320 and sv 322, respectively, wherein

sh=S·cos φ; sv=S·sin φ (3)

where S is the source strength. The φ-dependence from the vector projection is the same as that of the dipole source described in Eq. (1).

The sh 320 component, being transverse to the sagittal plane 308, generates a SH wave towards reflector plane 306, while the sv 322 component, being contained in the sagittal plane, emits a SV wave toward the reflector. The SH and SV waves traverse the same ray path from the source to the reflector, and back to the receiver 304.

In one embodiment, a cross-dipole acoustic tool comprising two orthogonal dipole source-receiver systems may be used to yield a four-component data set that can be used to determine the azimuth of the reflector. The receiver 304 records the reflected waves with x- and y-oriented dipole receivers. For the x-oriented source, after reflection from the reflector 306, the reflected SH and SV waves are projected onto the receiver and are recorded as the xx and xy component data, where xx indicates a signal emitted from an x-oriented source and recorded at an x-oriented receiver while xy indicates a signal emitted from an x-oriented source and recorded at an y-oriented receiver. The reflected waves are written as SH=T_{SH}S and SV=T_{SV}S, where T_{SH} and T_{SV} are respective transfer functions for the two waves. Thus measurements obtained at the x- and y-receivers are described in Eq. (4):

xx=SH·cos² φ+SV·sin² φ

xy=−SH·sin φ cos φ+SV·sin φ cos φ (4)

### Performing the same analysis for the y-dipole source of the same intensity S gives the yx and yy component data

yx=−SH·sin φ cos φ+SV·sin φ cos φ

yy=SH·sin² φ+SV·cos² φ (5)

where yx indicates a signal emitted from an y-oriented source and recorded at a x-oriented receiver while yy indicates a signal emitted from an y-oriented source and recorded at an y-oriented receiver.

The four-component cross-dipole data of Eqs. (4) and (5) may be recorded and combined to obtain the SH and SV reflected waves:

SH=xx·cos² φ+(xy+yx)·sin φ cos φ+yy·sin² φ

SV=xx·sin² φ−(xy+yx)·sin φ cos φ+yy·cos² φ (6)

The reflected SH and SV waves in Eq. (6) may differ from each other significantly in amplitude. In fact, they respectively contain the combined effect of source excitation (Eq. (3)), source radiation and receiver reception directivity, reflection, and propagation/attenuation, etc., in the incident plane. These effects are different for SH and SV waves. The reflection coefficients, for example, at the reflector plane are different for the two waves.

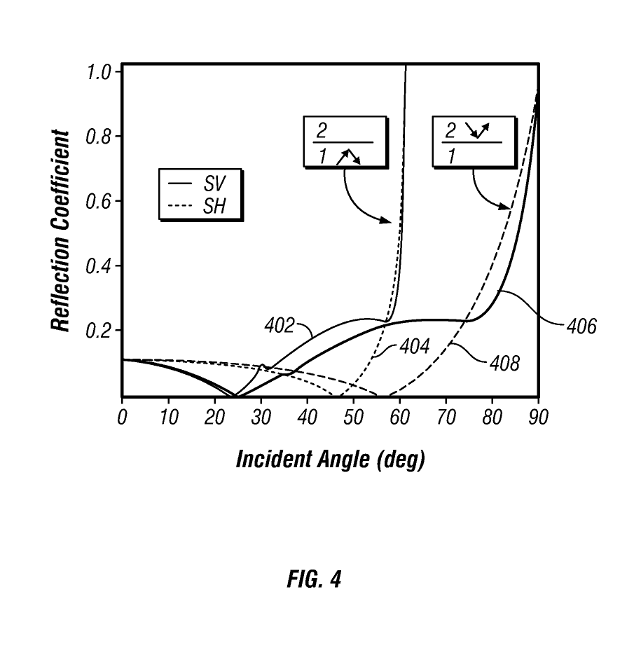

FIG. 4 shows a graph of angular dependence of reflection coefficients between two media for SV (solid) and SH (dashed) waves. The reflector plane forms the interface of the two media (i.e., medium 1 and medium 2) which may be geological formations and which typically have different elastic properties that are related to differences in their compositions. Table 1 displays elastic properties for two media forming sides of a reflector plane used to obtain the exemplary graph of FIG. 4. The reflection coefficients are calculated using the equations given in Aki and Richards, 1980, Quantitative seismology: theory and methods: W.H. Freeman and Co., San Francisco.

TABLE 1

| Medium | Density (kg/m³) | P-velocity (m/s) | S-velocity (m/s) |
|---|---|---|---|
| 1 | 2600 | 4000 | 2300 |
| 2 | 2400 | 3800 | 2000 |

In FIG. 4, solid lines 402 and 406 represent the angular dependence of reflection coefficients for the SV waves. Dashed lines 404 and 408 represent the angular dependence of reflection coefficients for the SH waves. In general, SV reflection coefficients are smaller than SH reflection coefficients between low and moderately high incident angles. Wave incidences from both sides (1→2 and 2→1) of the reflector boundary are calculated in order to simulate the logging of an acoustic tool from the lower side (1→2) and the upper side (2→1) of the bed boundary. The reflection coefficients for an acoustic tool at the lower side (1→2) are the SV coefficient 402 and SH coefficient 404. The reflection coefficients for and acoustic tool at the upper side (2→1) are the SV coefficient 406 and SH coefficient 408. For either scenario, a noticeable phenomenon is that the reflection vanishes at certain incident angles. This null-reflection angle is about 25°-30° for SV waves and 45°-60° for SH waves. The difference in SV versus SH reflection, combined with the difference in their radiation patterns (FIG. 2) can be used to distinguish the two waves.

From Eqs. (4) and (5), a single in-line dipole tool can always record reflected shear waves regardless of the orientation of the dipole tool. The in-line component xx or yy is a combination of both SV and SH reflection waves, although the contribution of the two waves varies with the tool orientation. Since the dipole data contains the SH and/or SV reflections, the dipole acoustic tool may be used for shear-wave reflection imaging.

The reflector strike azimuth φ can be obtained from the cross-component data xy and/or yx. These components, as shown in Eqs. (4) and (5), vanish when φ=0° or 90°. A simple physical explanation is that a dipole oriented either along or normal to the reflector strike generates only a pure SH or SV reflection, with no partition of reflection energy to the cross-component. Thus, the reflector azimuth can be obtained by minimizing the cross-component amplitude or energy.

A technique for determining the reflector azimuth is discussed in conjunction with practical considerations of the cross-dipole data. As the tool rotates, the tool's azimuth φ with respect to a bedding/reflector plane varies, and the amplitude of the recorded reflection waves also changes. As a result, when the data measured at different φ values are used to evaluate the azimuth, the azimuth information contained in the data gets distorted or even lost. The tool-rotation effect, if uncorrected, obscures the directional information of the measurement.

FIG. 3 also shows X- and Y-axes representing the axis of a fixed coordinate system. In practice, one can make the X- and Y-direction point in a predetermined direction, such as to the earth's north and west directions, respectively. The X-axis makes an angle α with the strike direction of the reflector. The angle between the X-axis and the x-axis of the tool-frame coordinates is the tool azimuth (AZ) which is recorded during logging. In dipole acoustic logging, the tool frame azimuth, AZ, relative to a fixed direction (e.g., the earth's north) is usually recorded for each tool position along the borehole. These angles are related by

α=AZ+φ (7)

With the measured tool azimuth, the coordinate transformation of Eq. (7) is used to convert the component data in Eqs. (4) through (6) of the x-y system into the component data in the X-Y fixed coordinate system. These components in the fixed coordinates are given as

XX=xx·cos² AZ−(xy+yx)·cos AZ·sin AZ+yy·sin² AZ

XY=(xx−yy)·cos AZ·sin AZ+xy·cos² AZ−yx ·sin² AZ

YX=(xx−yy)·cos AZ·sin AZ+yx·cos² AZ−xy sin² AZ

YY=yy·cos² AZ+(xy+yx)·cos AZ·sin AZ+xx·sin² AZ (8)

### Subsequent data processing using the new component data preserves the azimuth information in the resulting data.

Wave components in the fixed coordinate system are defined in the same way as their counterpart in the tool frame coordinates. For example, the XY component represents a wave emitted from a dipole source in the X-direction and recorded by a dipole receiver in the Y-direction. These components of Eq. (8) also satisfy Eqs. (4) through (6), noting that the azimuth φ in these equations is replaced by α (i.e., XY=(SH−SV)·cos α·sin α).

In the fixed coordinate system, the azimuth of a reflector is fixed. Therefore, the wave component data in Eq. (8) at various tool positions along the borehole maintain the same azimuth with respect to a reflector, regardless of the change of the tool azimuth, AZ, at these positions. These data can then be processed without losing the azimuth information.

Using the four-component data in the fixed coordinate system of Eq. (8), the reflector azimuth, αₒ, can now be estimated. The reflector azimuth αₒ is the reflector strike, which, when coinciding with the dipole orientation, results in the vanishing of the cross component data. Eq. (8) can be used to form the new cross-component data with an arbitrary orientation a relative to the fixed coordinate system.

XY′=(XX−YY)·cos α·sin α+XY·cos² α−YX·sin² α

YX′=(XX−YY)·cos α·sin α+YX·cos² α−XY·sin² α (9)

The reflector strike αₒ is obtained when the cross-component data vanish. The actual reflection data are time series samples over a recording time T. The individual reflection event spreads over a depth range Z. The data also contain various levels of noise. To process the data containing noise, the value of αₒ is obtained using an inversion procedure by minimizing the cross-component energy. The cross-component energy, or the objective function for the inversion, is constructed as the dot product of the cross components over the recording time T and depth range Z, as

$$E ( α ) = 〈 {XY}^{′} \cdot {YX}^{′} 〉 = {\int }_{Z} {\int }_{T} [ {XY}^{′} ( α ; z , t ) \cdot {YX}^{′} ( α ; z , t ) ] d t d z \qquad ( 10 )$$

Without having to perform the minimization of the above objective function, the solution for αₒ can be obtained analytically. The minimum of equations (10) is attained when

$$\frac{d E ( α )}{d α} = 0 \qquad ( 11 )$$

### Applying the condition of Eq. (11) to Eq. (10) yields an analytical formula to directly calculate αₒ from the four component data.

$$tan ( 4 {α}_{0} ) = \frac{2 \cdot 〈 ( YY - XX ) \cdot ( XY + YX ) 〉}{〈 ( XY + YX ) \cdot ( XY + YX ) 〉 - 〈 ( YY - XX ) \cdot ( YY - XX ) 〉} \qquad ( 12 )$$

### In the Eq. (12), the dot product of any two data vectors a and b, such as where a and b can be any one of the data combinations YY−XX and XY+YX, is calculated by

$$〈 a \cdot b 〉 = {\int }_{Z} {\int }_{T} [ a ( z , t ) \cdot b ( z , t ) ] d t d z \qquad ( 13 )$$

There are four solutions of αₒ for Eq. (10) in the 0°-180° azimuth range. Two solutions are maxima of Eq. (10) and are therefore are not considered. The other two solutions correspond to minima that are separated by π/2 (in radians), or 90° (in degrees). The minimum and maximum are separated by 45°. Their relative difference Eq. (14) reflects the difference (SH-SV) of Eqs. (4) and (5) and may be used indicate the effectiveness of the minimization:

$$Δ E = 2 \cdot \frac{{E}_{max} - {E}_{min}}{{E}_{max} + {E}_{min}} \qquad ( 14 )$$

### The two αₒ values that minimize E(α) correspond, respectively, to the strike and dip direction of the reflector (see FIG. 3) and are resolved from the solutions to SH and SV obtained using Eq. (6) and αₒ:

SH=XX·cos² α+(XY+YX)·sin α cos α+YY·sin² α

SV=XX·sin² α−(XY+YX)·sin α cos α+YY·cos² α (15)

whereas αₒ and αₒ+90° are both possible solutions to the above equations. Evaluating the SH and SV wave amplitudes resolves this 90° ambiguity.

SH wave reflections typically have larger amplitude compared to the SV wave reflections for several reasons. First, the amplitude of the radiated SV wave is smaller than that of the SH wave (see FIG. 2). Secondly, the reflection coefficient of the SV wave is smaller than that of the SH wave for incident angles up to a cross-over angle I_{c}, which is about 30°-40° or higher (see FIG. 4). Based on these results, the SH-to-SV wave energy ratio is defined by

$$\frac{SH - energy}{SV - energy} = \frac{{\int }_{Z} {\int }_{{T}^{′}} [ SH ( z , t ) \cdot SH ( z , t ) ] d t d z}{{\int }_{Z} {\int }_{{T}^{′}} [ SV ( z , t ) \cdot SV ( z , t ) ] d t d z} \qquad ( 16 )$$

where the energy integrals are calculated by using the SH and SV expressions in Eqs. (15).

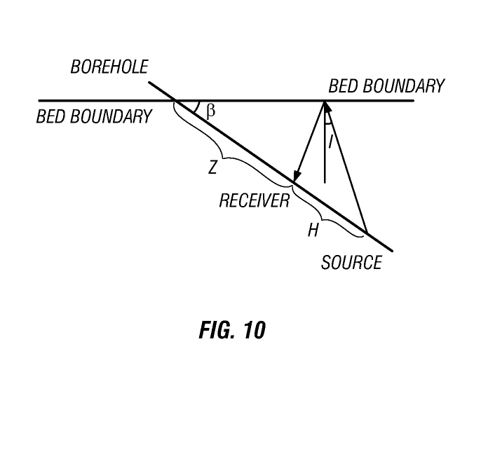

FIG. 10 illustrates a geometry of a testing tool conveyed in a borehole intersecting a reflector plane. According to Snell's law, the angle of incidence equals the angle of reflection for an acoustic ray striking the bed boundary. This angle, denoted by I, is related to the bed intersection angle β through the Eq. (17) derived using the geometry in FIG. 10.

$$tan I = ( \frac{H}{2 Z + H} ) / tan β \qquad ( 17 )$$

where Z is the receiver distance to the borehole-bed intersection, H is the source-receiver spacing, and β is the reflector angle with the borehole. The reflection travel time from source to receiver along the ray path may be written

$$T = \frac{d}{{V}_{s}} = \frac{\sqrt{{H}^{2} + 4 Z ( Z + H ) {sin}^{2} β}}{{V}_{s}} \qquad ( 18 )$$

where d is the wave travel distance in the formation and Vₛ is the formation shear velocity. For a given incident angle I_{c}, Eqs. (17) and (18) can be solved simultaneously to find the corresponding reflection travel time T, yielding the result of Eq. (19) below, where T₀=H/V_{S} is the source-to-receiver travel time.

For a source on a rotating tool, the time integration in the integrals covers only a time period T′ that includes the recording of reflections with source-to-reflector incident angles smaller than cross-over angle I_{c}. The period T′ starts with a time given by

$${T}_{s} = {T}_{0} \frac{cos β}{cos {I}_{c}} {\to }^{β = 90 ° - D} {T}_{0} \frac{sin D}{sin {I}_{c}} \qquad ( 19 )$$

where T₀ is the source-to-receiver shear travel time and β is the reflector angle with the borehole. For a vertical borehole, β is the complementary angle of the reflector dip D.

According to Eq. (19), if the formation dip is smaller than the cross-over angle I_{c} which is about 30°-40° (see FIG. 4), the entire recording time can be used. The SH and SV waves can be distinguished using the energy ratio in Eq. (16). If the ratio value is significantly larger (smaller) than 1, then αₒ (αₒ+90°) should be the SH-wave polarization direction corresponding to the strike direction of the reflector. Thus the use of the wave energy ratio helps resolve the azimuth ambiguity.

The migration of the shear-wave reflection data for imaging reflectors in formation uses the conventional seismic processing method. Perhaps one major difference of the borehole acoustic data, as compared to surface seismic data, is the large amplitude direct arrivals in the borehole data. These direct waves are removed before processing the secondary arrivals of much smaller amplitude using the method disclosed in Tang et al., US20070097788. For four-component cross-dipole data, the data components may first be converted to the fixed earth coordinates using Eq. (8) and then used for the reflection processing. The reflection waves, according to their moveout, are sorted into up-dip (reflected up-going) and down-dip (reflected down-going) subsets.

The up- and down-going reflection events, as obtained from the above-mentioned processing technique, are respectively migrated to image the upper and lower side of the formation reflector. For four-component data, the reflection data are used to obtain the reflector azimuth and the SH/SV reflection data obtained using this azimuth (Eq. (15)) are used for the migration/imaging. The SH reflection, compared to SV reflection, may obtain a better image for its better radiation and reflection characteristics. Several migration techniques can be used, e.g., the back-projection scheme using a generalized Radon transform (Hornby, 1989), or the commonly used Kirchoff depth migration method (Li et al., 2002), or the pre-stack f-k migration method adapted to acoustic logging configuration (Zheng and Tang, 2005). The shear-wave migration procedure needs a shear velocity model to correctly map the reflection events to the position of a formation reflector. For the dipole shear-wave logging data, the S-wave shear velocity obtained from the shear logging measurement is conveniently used to build the velocity model (Hornby, 1989; Li et al., 2002).

After migration, the shear-wave reflection data are mapped into a two-dimensional (2D) domain. One dimension is the radial distance away from the borehole axis; the other is Z, the logging depth, or the tool position, along the borehole. Structural features of reflectors, such as dip/inclination and continuation, etc. on the image map can then be analyzed to provide information about the geological structures.

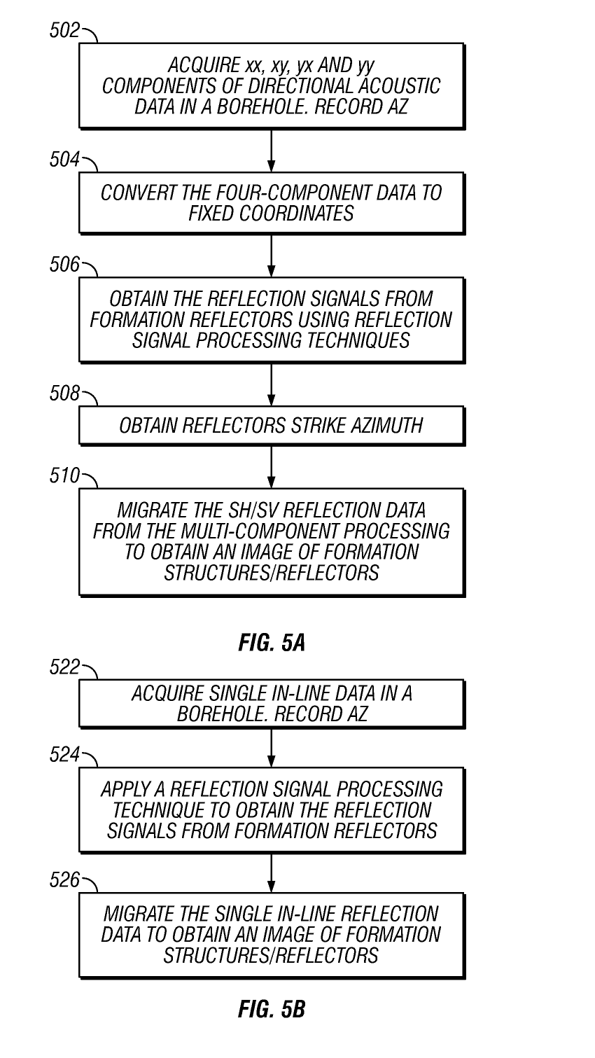

FIG. 5A shows a flowchart of a procedure for determining a bedding plane orientation using directional acoustic logging data obtained from four-component cross-dipole acoustic logging tool of the present disclosure in a borehole. In Box 502, directional acoustic data is acquired with a four-component cross-dipole acoustic logging tool in a borehole. The azimuth AZ of the tool is recorded relative to a fixed coordinate system. The cross-dipole data include the four components xx, xy, yx and yy. To maintain the azimuth information in the presence of tool rotation, the measured data in the tool-frame coordinates is converted into a fixed coordinate system. In Box 504, the four component data is converted to the fixed coordinate system using Eq. (8). In Box 506, a reflection signal processing technique is applied to each component in the fixed coordinate system to obtain the reflection signals from formation reflectors. In Box 508, the reflector strike azimuth is obtained from the multi-component data by minimizing Eq. (10) and by using the energy ratio in Eq. (16). The azimuth is used to obtain SH/SV reflection data. In Box 510, the SH/SV reflection data is migrated from the multi-component processing to obtain an image of formation structures/reflectors.

FIG. 5B shows a flowchart of the processing procedures for determining the bedding plane orientation using a single in-line acoustic logging data. In Box 522, directional acoustic data is acquired with a single in-line acoustic logging tool in a borehole and the azimuth AZ of the tool is recorded relative to a fixed coordinate system. In Box 524, the reflection signal processing technique of Tang et al. (U.S. Pat. No. 7,035,165) is applied to the in-line data in the fixed coordinate system to obtain the reflection signals from formation reflectors. The signals contain the contribution from both SH and SV waves (Eq, (4)). In Box 526, the single in-line reflection data is migrated to obtain an image of formation structures/reflectors.

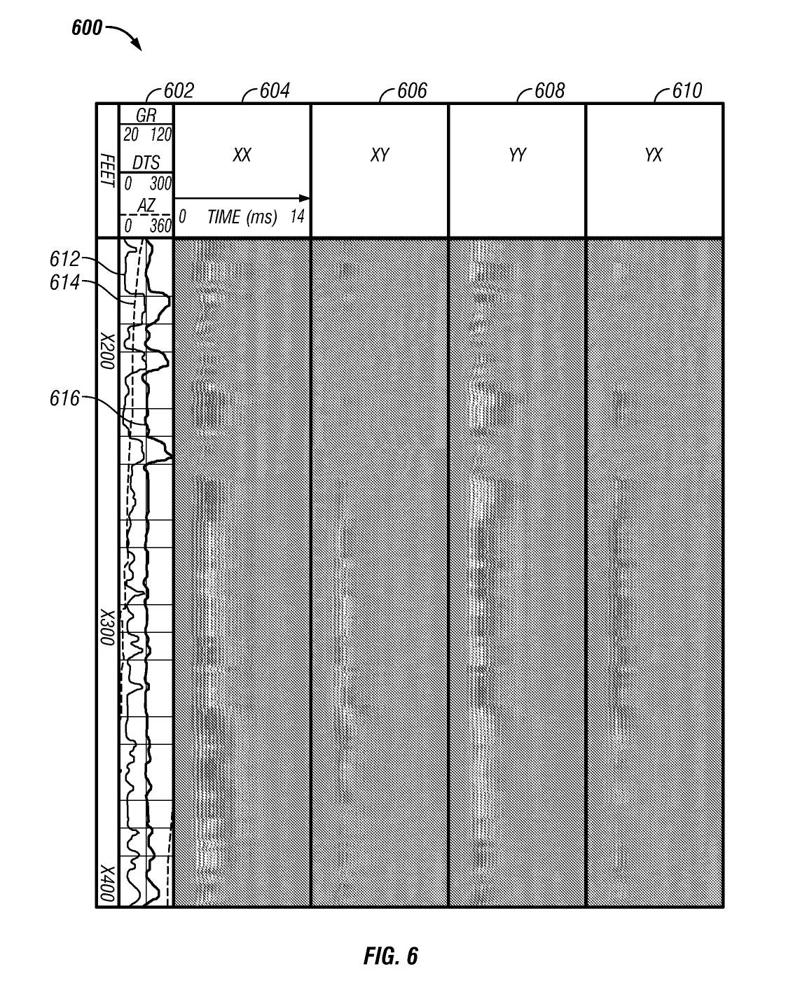

FIG. 6 shows an example of four-component cross-dipole data 600 acquired in a vertical well surrounded by a sand/shale formation. The gamma ray 612, tool azimuth 614, and shear-wave slowness 616 curves, as respectively denoted by GR, AZ, and DTS, are shown in Track 1 (602). The need to apply the coordinate conversion is shown by the significant change of the tool azimuth curve across the depth interval of about 240 ft. Shown in tracks 2 through 5 are VDL display of the converted data (XX 604, XY 606, YX 608, and YY 610) after application of Eq. (8) to the original data. Only data from a single receiver of an eight receiver array is displayed in FIG. 6.

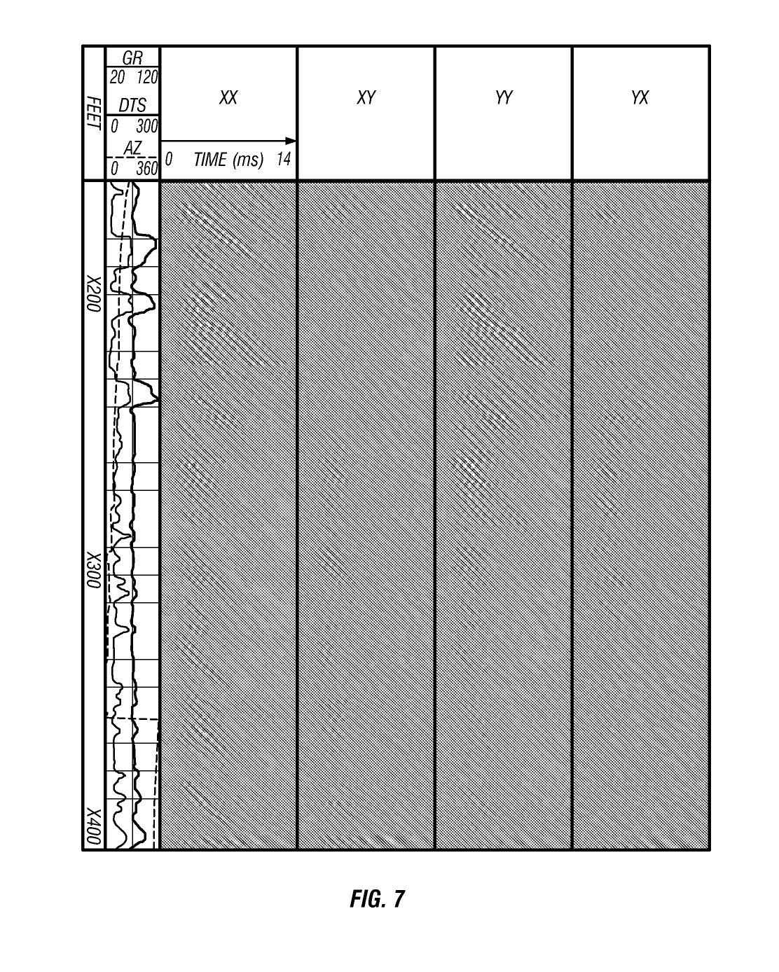

The data corresponding to FIG. 6 are processed in a low-frequency range around 1.5 kHz to extract the reflection signals in the data. In the low-frequency range, the dispersion effect of the dipole-flexural waves is removed so that its contamination to the reflection signals is minimal. FIG. 7 shows the four-component data after the reflection processing. The maximum amplitude of the VDL in FIG. 7 is about a factor of 100 smaller than that of the direct wave data in FIG. 6. A typical reflection processing is described in Tang et al., 2006, and separates the reflection data into up- and down-going reflections. FIG. 7 shows only the down-going reflection data. The reflection data are used to determine the bed strike azimuth using Eq. (12).

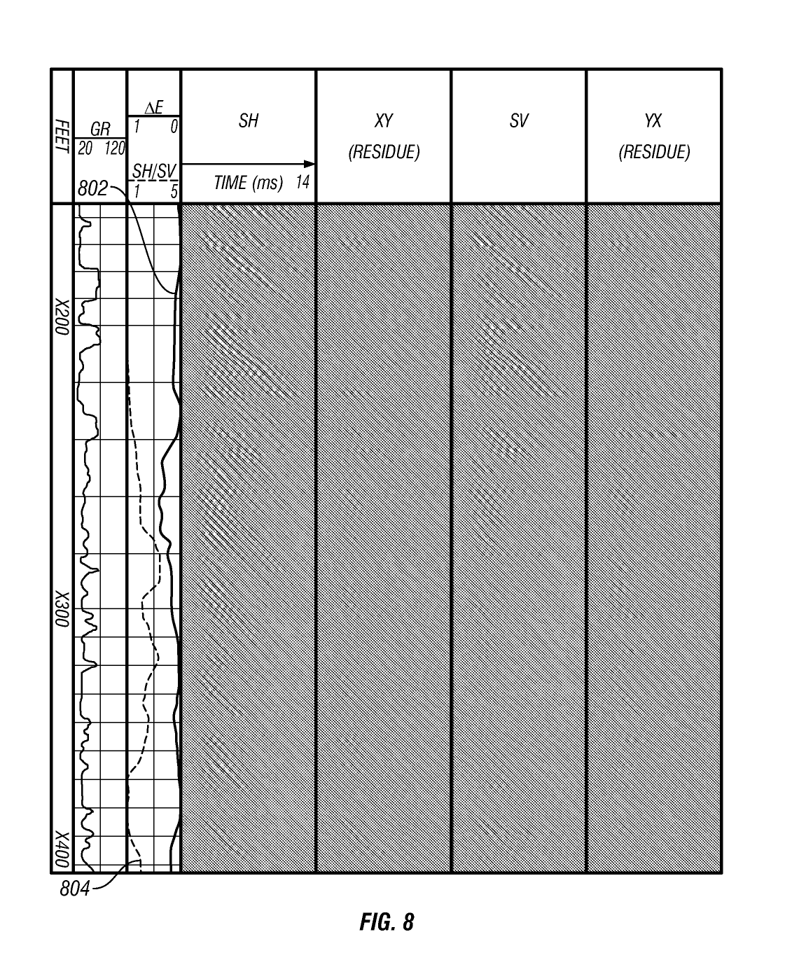

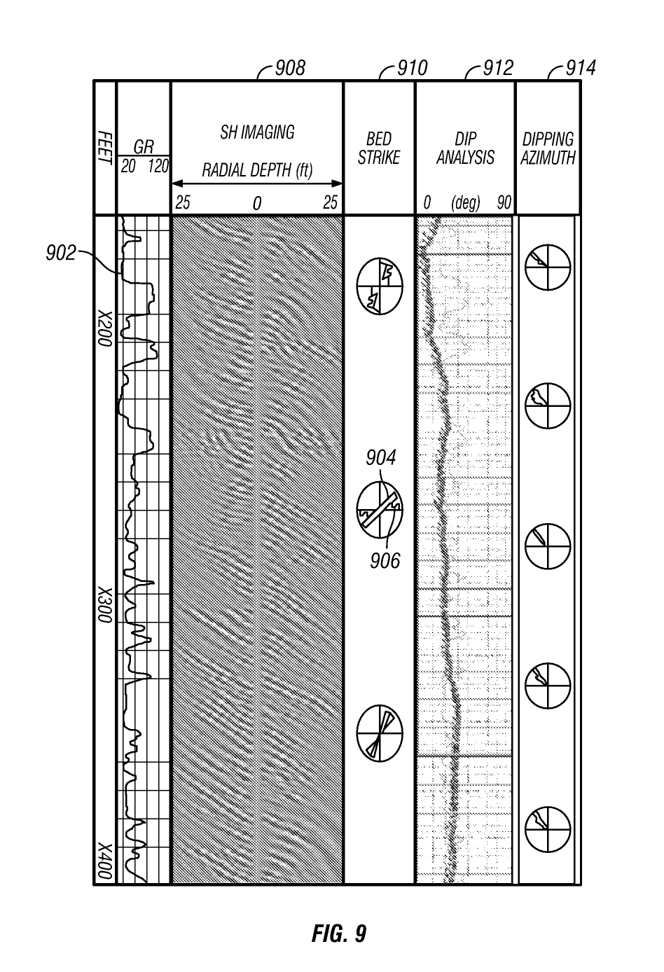

FIG. 8 shows the resulting four-component data after reflection processing and the maximum versus minimum cross-energy difference ΔE 802 calculated using Eq. (14) and SH-versus-SV ratio 804 calculated using Eq. (16) for the entire recording time T′=T. The large value of the difference curve 802 indicates the effectiveness of the minimization. The greater-than-one value of the ratio curve 804 indicates that the determined azimuth corresponds to the SH wave polarization and is therefore the bed strike azimuth. The SV reflections are small in the lower depths and become comparable to the SH reflections toward the upper depths. This change in SV is closely related to the formation bed dip variation in the depth interval shown in FIG. 9. In the lower section, the bed dip is about 20°-30° and the SV reflection is close to the reflection-null angle (see FIG. 4). The dip/reflection angle decreases toward the top, and the SV reflection amplitude increases correspondingly.

FIG. 9 shows an obtained image of bed-boundary reflectors across an exemplary borehole. The image is obtained by migrating the up- and down-going SH-wave reflection data, which were obtained by processing the SH wave data (first equation of equations (15)) using the method describe by Tang '788. The up-going data gives the up-dip image while the down-going data gives the down-dip image, both being displayed in the radial depth range of 25 ft. The image shows several bed reflectors, whose intersections with the borehole correspond to shale streaks in the formation (see GR curve 902 in track 1). The dip angle of the beds is about 30°, with a tendency to decrease with decreasing depth. In the upper interval the image quality decreases despite the large reflection amplitude (see FIG. 8). This relates to the inability to image reflectors when their intersection angle with the borehole approaches 90°.

Two bed strike azimuth results are shown using the azimuth diagram in track 3 (810). One azimuth (darker shading 904) is obtained from using the down-dip reflection data and the other azimuth (lighter shading 906) is obtained using the up-dip data. The two azimuths agree reasonably well, both showing a azimuth range within NEE and ENE. The shear-wave imaging results 908 are compared with the dip log analysis results in tracks 4 (912) and 5 (914). The dip log results show the bed dip is about 30° at the lower section and becomes about 20° or lower toward the upper section. The bed dipping direction is within the WNW and NW range. The dip log results are in reasonable agreement with the shear-wave imaging results.

The above-mentioned analyses and procedure have been applied to shear waves from a cross-dipole logging data set. The resulting orientation and dip of formation bed boundaries are found to be consistent with those from a dip log analysis.

The method of the present disclosure has been described with reference to a wireline conveyed tool. The method may also be done using a dipole tool conveyed on a bottomhole assembly in an MWD configuration.

The processing of the data may be done by a processor to give corrected measurements substantially in real time. Implicit in the control and processing of the data is the use of a computer program on a suitable machine readable medium that enables the processor to perform the control and processing. The machine readable medium may include ROMs, EPROMs, EEPROMs, Flash Memories and Optical disks.

What is claimed is:

1. A method of determining a parameter of interest of a bed boundary of an earth formation, the method comprising:
(a) generating acoustic waves in the earth formation using a plurality of transmitters on a multicomponent logging tool in a borehole in the formation and obtaining a plurality of multicomponent acoustic measurements of shear waves reflected from the bed boundary for each of the plurality of transmitters, the multicomponent measurements indicative of the parameter of interest;
(b) using an orientation sensor on the logging tool for obtaining an orientation measurement indicative of an orientation of the logging tool;
(c) rotating the plurality of multicomponent measurements to a fixed coordinate system using the orientation measurement, giving rotated multicomponent measurements;
(d) processing the rotated multicomponent measurements and obtaining therefrom the parameter of interest of the bed boundary.

2. The method of claim 1 wherein the parameter of interest comprises one of (i) an azimuth of the bed boundary, and (ii) a dip of the bed boundary relative to an axis of the borehole.

3. The method of claim 1 wherein the multicomponent measurements comprise at least one of (i) a measurement made with a cross-dipole tool, (ii) a measurement made with a monopole source into a dipole receiver, and (iii) a measurement made with a dipole source into a monopole receiver.

4. The method of claim 1 wherein the orientation sensor comprises a magnetometer.

5. The method of claim 1 wherein the fixed coordinate system includes an axis aligned with one of (i) magnetic north, (ii) geographic north, and (iii) high side of a deviated borehole.

6. The method of claim 1 wherein the processing further comprises at least one of (i) applying a high pass filtering, (ii) determining a first break, (iii) using survey information indicative of a position of a source and a receiver on said logging tool, (iv) applying an f-k filtering operation, (v) applying a dip median filter, and (vi) selecting a time window.

7. The method of claim 1 wherein the multicomponent measurements comprise measurements made with a plurality of distances between a source and a receiver on the logging tool.

8. The method of claim 7 wherein the processing further comprises performing a migration and producing a plurality of migrated image data sections.

9. The method of claim 8 wherein the processing further comprises fitting a line to a linear trend on one of the plurality of migrated image data sections and determining a relative dip angle.

10. The method of claim 7 wherein the processing further comprises inverting the plurality of migrated image data sections and obtaining an azimuth angle, the inversion based at least in part on minimizing a cost function over an image area of interest.

11. The method of claim 1 wherein the parameter of interest comprises an azimuth of the bed boundary, the method further comprising determining a ratio of two of said multicomponent measurements.

12. The method of claim 10 wherein the multicomponent measurements comprise measurements made with a cross-dipole tool, the method further comprising using other data for resolving an ambiguity in said obtained azimuth angle.

13. The method of claim 1 further comprising conveying the multicomponent logging tool into the borehole on a conveyance device selected from (i) a wireline, and (ii) a drilling tubular.

14. An apparatus configured for evaluating an earth formation, the apparatus comprising:
(a) a downhole assembly configured to be conveyed in a borehole in said earth formation;
(b) a multicomponent logging tool on said downhole assembly, the multicomponent logging tool including:
(i) a multicomponent transmitter configured to generate acoustic waves in the formation, and
(ii) a multicomponent receiver configured to obtain a plurality of multicomponent acoustic measurements of shear waves reflected from a bed boundary indicative of a property of the boundary in said earth formation;
(c) an orientation sensor on the downhole assembly configured to provide an orientation measurement indicative of an orientation of the downhole assembly; and
(d) a processor configured to:
(A) rotate the plurality of multicomponent measurements to a fixed coordinate system using the orientation measurement, giving rotated multicomponent measurements, and
(B) process the rotated multicomponent measurements and estimate therefrom the property of the bed boundary.

15. The apparatus of claim 14 wherein said property of said bed boundary comprises (i) an azimuth of the bed boundary, and (ii) a dip of the bed boundary relative to an axis of the borehole.

16. The apparatus of claim 14 wherein said multicomponent measurements comprise at least one of (i) a measurement made with a cross-dipole tool, (ii) a measurement made with a monopole source into a dipole receiver, and, (iii) a measurement made with a dipole source into a monopole receiver.

17. The apparatus of claim 14 wherein said orientation sensor comprises a magnetometer.

18. The apparatus of claim 14 wherein said fixed coordinate system includes an axis aligned with one of (i) magnetic north, (ii) geographic north, and (iii) high side of a deviated borehole.

19. The apparatus of claim 14 wherein the processor is further configured to perform at least one of (i) applying a high pass filtering, (ii) determining a first break, (iii) using survey information indicative of a position of a source and a receiver on said logging tool, (iv) applying an f-k filtering operation, (v) applying a dip median filter, and, (vi) selecting a time window.

20. The apparatus of claim 14 wherein the multicomponent measurements comprise measurements made with a plurality of distances between a source and a receiver on said logging tool.

21. The apparatus of claim 20 wherein the processor is further configured to perform a migration and producing a plurality of migrated image data sections.

22. The apparatus of claim 21 wherein the processor is further configured to invert said plurality of migrated image data sections and obtain an azimuth angle, the inversion based at least in part on minimizing a cost function over an image area of interest.

23. The apparatus of claim 14 wherein the property of the bed boundary comprises an azimuth of the bed boundary, and the processor is further configured to determine a ratio of two of said multicomponent measurements.

24. The apparatus of claim 14 further comprising a conveyance device configured to convey the logging tool into the borehole, the conveyance device selected from (i) a wireline, and (ii) a drilling tubular.

25. A computer-readable medium for use with an apparatus configured for evaluating an earth formation, the apparatus comprising:
(A) a downhole assembly configured to be conveyed in a borehole in said earth formation;
(b) a multicomponent logging tool on said downhole assembly, the multicomponent logging tool including:
(i) a multicomponent transmitter configured to generate acoustic waves in the formation; and
(ii) a multicomponent receiver configured to obtain a plurality of multicomponent acoustic measurements of shear waves reflected from a bed boundary indicative of a property of the boundary in said earth formation; and
(c) an orientation sensor on the downhole assembly configured to provide an orientation measurement indicative of an orientation of the downhole assembly;
the medium comprising instructions that enable a processor to:
(d) rotate the plurality of multicomponent measurements to a fixed coordinate system using the orientation measurement, giving rotated multicomponent measurements, and
(e) process the rotated multicomponent measurements and estimate therefrom the property of the bed boundary.

26. The medium of claim 25 further comprising at least one of (i) a ROM, (ii) an EPROM, (iii) an EEPROM, (iv) a flash memory, and (v) an optical disk.
